(19) United States
(12) Patent Application Publication
(10) Pub. No.: US 2004/0196315 A1
(43) Pub. Date: Oct. 7, 2004

(54) Method and apparatus for management of a primary buddy list in an instant messaging system

(75) Inventors: Craig Ardner Swearingen, Austin, TX (US); Alan Richard Tannenbaum, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 10/405,460

(22) Filed: Apr. 1, 2003

(51) Int. Cl. G09G 5/00

(52) U.S. Cl. 345/804

(57) ABSTRACT

A method, an apparatus, a system, and a computer program product are presented for organizing user information in an instant messaging application through the use of buddy lists and primary buddy lists. Buddy lists contain buddy objects that represent buddies in an instant messaging system, i.e. other users of an instant messaging system that are known to a particular user. Information that is associated with a buddy object is displayed within a first window of the instant messaging application. At some point in time, a user requests to designate the buddy object as a primary buddy object, and in response, information associated with the buddy object is then displayed in a second window of the instant messaging application which contains information associated with primary buddy objects. User requests to put a buddy in a primary buddy list may be performed through a variety of operations.

### BACKGROUND OF THE INVENTION

1. Field of the Invention

The present invention relates to an improved data processing system and, in particular, to a method and system for multi-computer data transferring. Still more particularly, the present invention provides a method and system for multi-user communication using instant messaging.

2. Description of Related Art

In most instant messaging applications, a user is given the ability to maintain a buddy list. A buddy is another user of the instant messaging application with which the user often exchanges instant messages, and a buddy list displays the online status of each buddy. By displaying the buddy list in an open window of a client device, the user has the ability to easily monitor the online status of the user's buddies, and when the user notices that a particular buddy's status has changed from offline to online, the user can quickly initiate an instant messaging session with that particular buddy.

Over time, a user's buddy list tends to grow in length and can often contain numerous entries, particularly within a corporate environment in which a user often adds buddies for temporary projects and purposes. Instant messaging applications typically allow a user to manage buddies within a tree-like structure. However, this management technique is convenient for only relatively small buddy lists. After a buddy list grows in excess of a couple of dozen users, it becomes much more inconvenient to locate a given buddy within one's buddy list.

Therefore, it would be advantageous for an instant messaging application to provide alternate mechanisms for managing information about buddies.

### SUMMARY OF THE INVENTION

A method, an apparatus, a system, and a computer program product are presented for organizing user information in an instant messaging application through the use of buddy lists and primary buddy lists. Buddy lists contain buddy objects that represent buddies in an instant messaging system, i.e. other users of an instant messaging system that are known to a particular user. Information that is associated with a buddy object is displayed within a first window of the instant messaging application. At some point in time, a user requests to designate the buddy object as a primary buddy object, and in response, information associated with the buddy object is then displayed in a second window of the instant messaging application which contains information associated with primary buddy objects. User requests to put a buddy in a primary buddy list may be performed through a variety of operations.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A depicts a block diagram that shows a typical instant messaging system;

FIG. 2B depicts a diagram that shows a typical graphical user interface window for an instant messaging application that shows the text of an instant messaging session;

FIG. 2C depicts a diagram that shows a typical graphical user interface window for an instant messaging application that shows an IM contact list or buddy list;

FIG. 3 depicts a block diagram that shows an example of an instant messaging system that has been extended to include the primary buddy list functionality of the present invention;

FIG. 4 depicts a flowchart that shows a process by which a user of an instant messaging application can designate primary buddy objects through a dragging operation in a graphical user interface window;

FIG. 5 depicts a flowchart that shows a process by which a user of an instant messaging application can designate primary buddy objects by editing properties of a buddy object in a graphical user interface window;

FIG. 6 depicts a diagram that shows a graphical user interface window for allowing a user to edit the properties of a buddy object in instant messaging application in order to designate a buddy object as a primary buddy object in accordance with the present invention; and

FIGS. 7-9 depict graphical user interface windows that show a primary buddy list in an instant messaging application.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

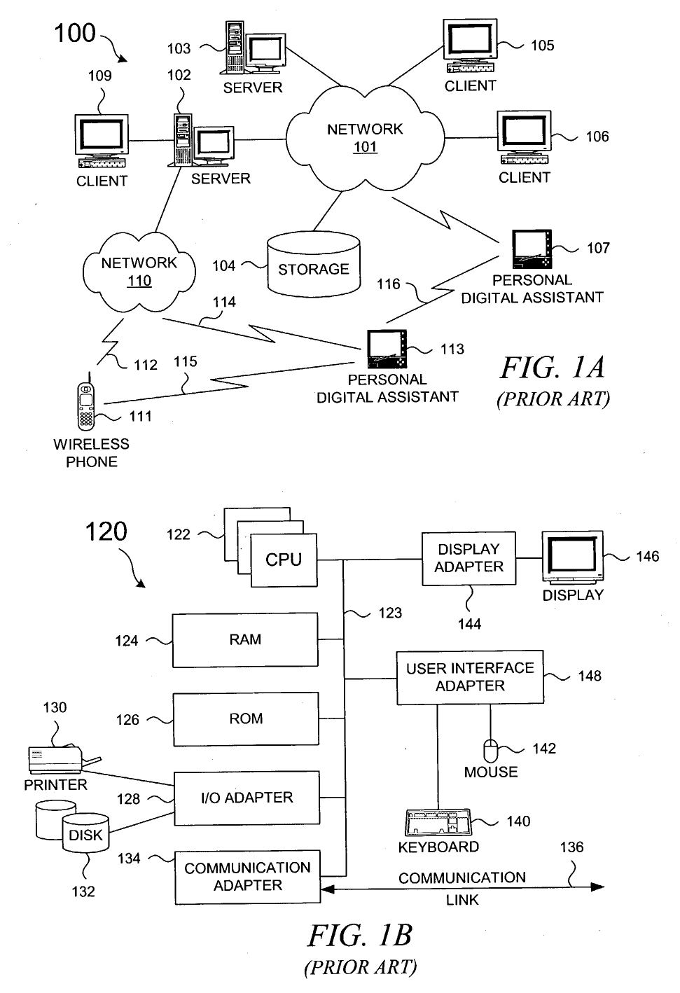

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), Common Presence and Instant Messaging (CPIM) protocols, etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to operating an instant messaging system, as described in more detail below with respect to the remaining figures. It should be noted that the examples that are described hereinbelow often refer to users and systems; it should be understood that a user interacts with a system such that the system performs actions on behalf of a user, and the terms “user” and “system” can sometimes be interchanged in a well-known manner to facilitate the description of operations at a data processing system.

Similarly, the examples include descriptions of a buddy and a buddy object. A buddy is a remote user of an instant messaging application (client application) with which a user of a local instant messaging application often exchanges instant messages. A buddy is represented by an instant messaging application with an appropriate data entity or data object, herein referred to as a buddy object. A buddy object may comprise many attributes, properties, or other types of information. The buddy object may be presented on a display device in a visual manner by an instant messaging application; the information that is displayed may be a graphical representation of a buddy object, such as a thumbnail picture or an icon, or the information may be in some other form, such as a textual identifier. The description of the invention hereinbelow relies on a well-understanding of the operation of graphical user interfaces in which visual/textual objects on a display device represent a series of abstractions. The user interacts through the graphical user interface to manipulate visually represented data objects, which may represent some other type of data object, such as a buddy object, which itself represents a real user. Hence, the terms “buddy”, “buddy object”, or some other term for an associated data object can sometimes be interchanged in a well-known manner to facilitate the description of operations at a data processing system.

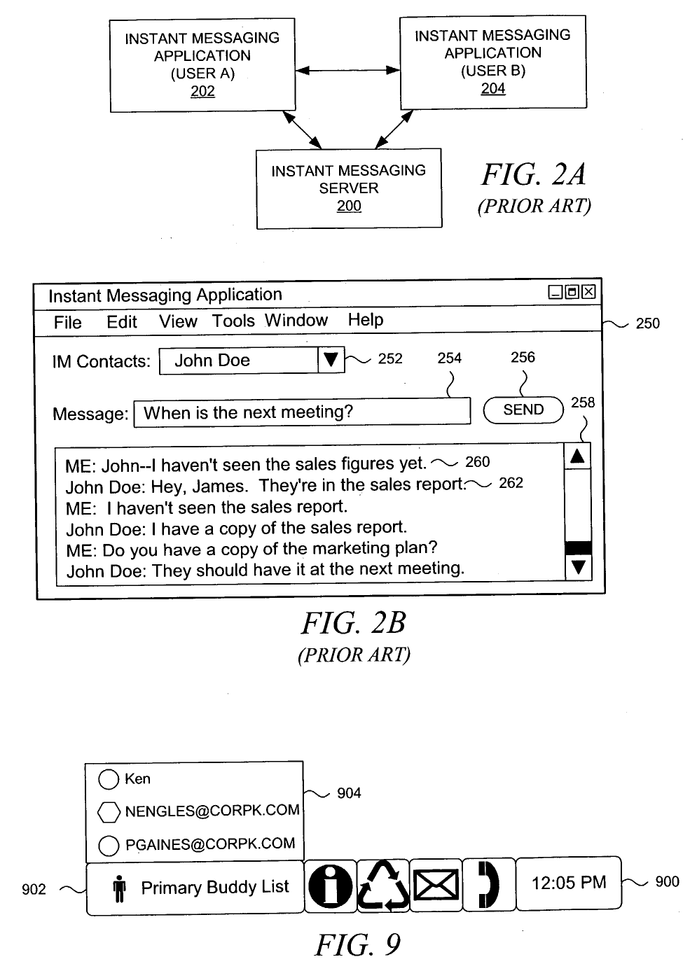

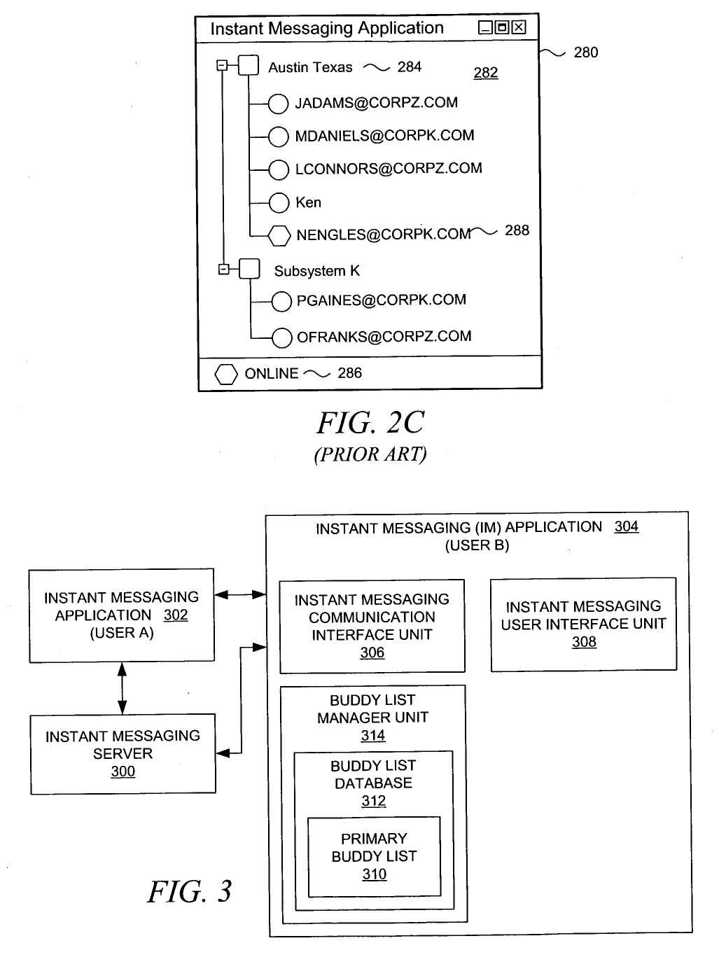

With reference now to FIG. 2A, a block diagram depicts a typical instant messaging system. Typical instant messaging systems have characteristics of a client/server organization and a peer-to-peer organization. Instant messaging (IM) server 200 authenticates a user of an instant messaging application, such as instant message application instances 202 and 204. After authenticating a user, the instant messaging server will perform certain operations on behalf of the instant messaging application. In this manner, an instance of an instant messaging application operates as an instant messaging client. The instant messaging server maintains some type of session for each active instant messaging client, which eventually logs out from the session or allows the session to undergo a timeout termination.

However, after being initialized with certain information, depending on the communication protocol, active instant messaging clients can communicate directly with each other by transferring instant messages directly to another active instant messaging client without assistance from the instant messaging server. In this manner, the separate instances of the instant messaging application act as peer nodes in a peer-to-peer network. Many instant messaging systems employ proprietary protocols, although standard instant messaging protocols have been proposed, e.g., Crocker et al., “Common Presence and Instant Messaging (CPIM)”, Internet Draft of the Internet Engineering Task Force (IETF), draft-ietf-impp-cpim-03.txt, 08/2002. The exemplary embodiments of the present invention that are described hereinbelow are intended to operate with proprietary or non-proprietary protocols regardless of the instant messaging system or framework.

For example, assuming that a user has previously registered for an account with the instant messaging server, a user logs into the instant messaging server through an instant messaging application on a client device. The instant messaging server stores the connection information for the client device, such as the IP address of the client device and the port number that is assigned to the instant messaging application at the client device.

During the login operation, the instant messaging server also receives and stores an IM contact list, often referred to as a buddy list, for the user along with the user's connection information and other session information. The server performs an initial check to see if the users in the buddy list are online and notifies the user's active instant messaging client of the online status of those users, e.g., whether those users are online and available for communication through the instant messaging system. The server monitors these buddy lists such that when a user logs into the instant messaging system, the server notifies anyone who has the recently logged-in user within a buddy list that the recently logged-in user is now online.

When the instant messaging server notifies a first instant messaging client that a second instant messaging client is online, the instant messaging server sends the connection information for the second instant messaging client to the first instant messaging client and perhaps vice versa depending upon the online status of the user. Because each active instant messaging client has connection information for other active instant messaging clients in the instant messaging system, these instant messaging clients can transfer instant messages between themselves without interaction with the instant messaging server, i.e. in a peer-to-peer manner.

With reference now to FIG. 2B, a diagram depicts a typical graphical user interface window for an instant messaging application that shows the text of an instant messaging session. Text strings and file attachments for the instant messages of an instant messaging session are presented to a user of an active instant messaging client in a GUI window. Window 250 is presented on a display device connected to a data processing system on which an instance of an instant messaging application is executing for a user. In a typical fashion for an instant messaging application, window 250 contains several user interface controls for operating the instant messaging application. Drop-down menu 252 contains the user's contact list. Text entry field 254 allows entry of a text string to be sent as an instant message. “SEND” button 256 initiates a transmit operation to generate and send the contents of the text entry to the selected instant message contact.

A history of the instant messages within an instant messaging conversation is typically shown within a scrolling window; it is expected that both users of the instant messaging session will view the same content within their respective GUI windows during an instant messaging conversation. Scrollable text area 258 contains the history of the instant messaging conversation. Text line 260 is the initial instant message that was sent by a local user to the remote user; text line 262 is the response from the remote user, and the remaining text lines in text area 258 reflect instant messages for the continuing conversation. The instant messaging application may separately maintain different conversations in different windows during a user's instant messaging session, which may run for an extended period of time, e.g., during business hours within a corporate context.

With reference now to FIG. 2C, a diagram depicts a typical graphical user interface window for an instant messaging application that shows an IM contact list or buddy list. For a given user of an instant messaging application or system, a buddy is a remote user of the instant messaging system with whom the given user exchanges instant messages. Most instant messaging applications provide a mechanism for organizing information about a list of buddies. Window 280 is a typical GUI window for a buddy list within an instant messaging application. Buddy list area 282 shows multiple buddies in a buddy list, and the buddy list is organized in a hierarchical fashion with buddies possibly included within a group of buddies, such as group 284.

As mentioned above, the instant messaging server monitors these buddy lists such that when a user logs into the instant messaging system, the server notifies anyone who has the recently logged-in user within a buddy list that the recently logged-in user is now online. In this manner, instant messaging users are constantly aware of the online status of the users within their buddy lists because an instant messaging client is updated relatively quickly with the appropriate information. The instant messaging client typically provides a special visual indicator in a buddy list window for online buddies, such as visual indicator 286. Each buddy object in the buddy list that is online has an associated online indicator, such as online buddy 288. By glancing at a visual representation of a buddy object, a user can quickly determine whether the buddy represented by the buddy object is offline or online.

As mentioned above, over time, a user's buddy list tends to grow in length and can often contain numerous entries, particularly within a corporate environment in which a user often adds buddies for temporary projects and purposes. After a buddy list grows in excess of a couple of dozen users, it becomes much more inconvenient to locate a given buddy within one's buddy list. The present invention is directed to a mechanism for managing a list of buddies that have been designated as primary buddies by a user. The present invention is described in more detail below with respect to the remaining figures.

With reference to FIG. 3, a block diagram depicts an example of an instant messaging system that has been extended to include the primary buddy list functionality of the present invention. In a manner similar to the system that is shown in FIG. 2, the system that is shown in FIG. 3 illustrates instant messaging server 300 with two instances of an instant messaging application 302 and 304. In a typical fashion, instant messaging client 304 comprises components for interacting with remote instant messaging clients, e.g., instant messaging communication interface unit 306, and components for interacting with a local user, e.g., instant messaging user interface unit 308, along with other components; it may be assumed that active instant messaging client 302 comprises similar components that are not shown in FIG. 3.

In contrast to FIG. 2, FIG. 3 shows that an instant messaging application has been enhanced to include primary buddy list information 310 that supports the primary buddy list functionality of the present invention. In a preferred embodiment, primary buddy list information 310 is managed along with buddy list information for other buddies that have not been designated as primary buddies, e.g., through storage in a common buddy list database, such as buddy list database 312. Through a variety of means that are described in more detail further below, buddy list manager unit 314 allows a user to designate buddies within a buddy list as primary buddies through a graphical user interface, after which a property of a buddy object that is stored in buddy list database 312 is updated. In addition, buddy list manager unit 314 may create special database records for managing primary buddy objects as a group.

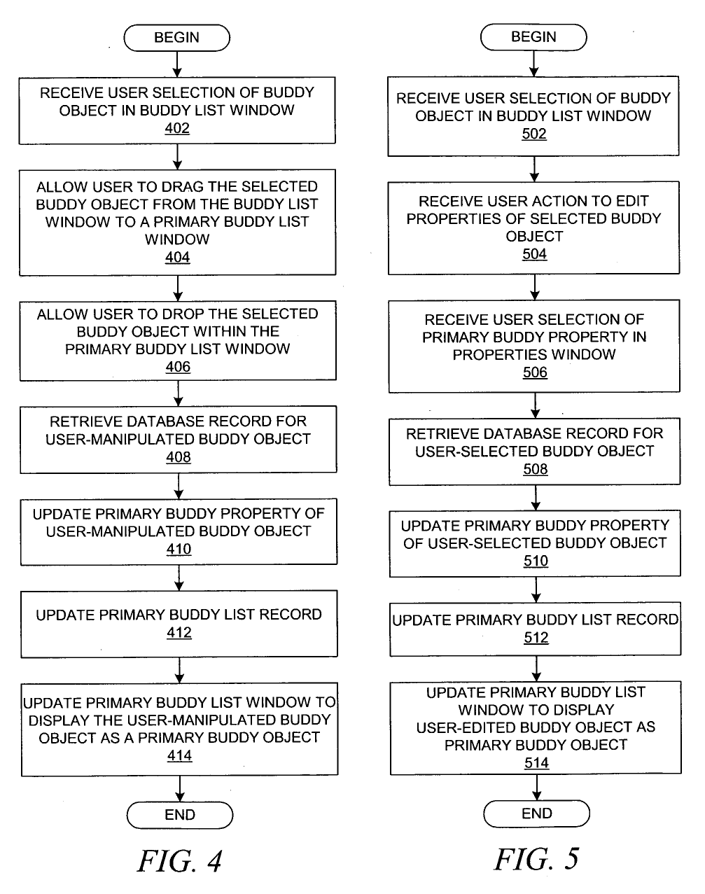

With reference now to FIG. 4, a flowchart depicts a process by which a user of an instant messaging application can designate primary buddy objects through a dragging operation in a graphical user interface window. The process begins with the instant messaging application displaying a buddy list window in which the user may select a buddy object through a typical GUI operation with a user input device (step 402). The instant messaging application, in coordination with the GUI and the operating system of the client device, allows the user to drag the selected buddy object from the buddy list window to a primary buddy list window (step 404). The user may then drop the selected buddy object within the primary buddy list window (step 406).

In response, the instant messaging application interprets the drag-and-drop operation of the buddy object into the primary buddy list window as a user designation of the buddy object as a primary buddy object. The instant messaging application retrieves the appropriate data object that is associated with the buddy object (step 408), such as a database record, and modifies the data object to reflect that the buddy object has now been designated as a primary buddy object by the user (step 410), preferably by setting a value of a primary buddy property within the data object. If necessary, other special data structures, such as data objects that represent the primary buddy list as a whole, are also updated (step 412). The instant messaging application then updates the primary buddy list window to display the user-manipulated, i.e. user-selected and modified, buddy object as a primary buddy object within the primary buddy list window (step 414), and the process is concluded.

With reference now to FIG. 5, a flowchart depicts a process by which a user of an instant messaging application can designate primary buddy objects by editing properties of a buddy object in a graphical user interface window. The process begins with the instant messaging application displaying a buddy list window in which the user may select a buddy object through a typical GUI operation with a user input device (step 502). The instant messaging application, in coordination with the GUI and the operating system of the client device, allows the user to perform an action that request an editing operation on the selected buddy object in the buddy list window (step 504), e.g., through a button-down event on a secondary button on a user input device, often referred to as a right-button click. In response, the instant messaging application may show a pop-up menu with a variety of actions that are possible on the buddy object, including a “Properties” menu item that allows the user to view and edit properties that are associated with the buddy object.

In response, the instant messaging application displays a properties window for the selected buddy object in which the user may select a primary buddy property (step 506), e.g., by selecting a checkbox option within the properties window in which the checkbox option is labeled and associated with a primary buddy property. The instant messaging application retrieves the appropriate data object that is associated with the selected buddy object (step 508), such as a database record, and modifies the data object to reflect that the buddy object has now been designated as a primary buddy object by the user (step 510), preferably by setting a value of a primary buddy property within the data object. If necessary, other special data structures, such as data objects that represent the primary buddy list as a whole, are also updated (step 512). The instant messaging application then updates the primary buddy list window to display the user-edited, i.e. user-selected and modified, buddy object as a primary buddy object within the primary buddy list window (step 514), and the process is concluded.

While FIG. 4 and FIG. 5 represent two different methods for designating primary buddy objects, it should be noted that other methods for designating primary buddy objects may be incorporated into an alternative implementation of the present invention. Also, while a user may remove a primary buddy property from a buddy object through a process similar to that shown in FIG. 5 in which the primary buddy property is cleared rather than set, it should be noted that the primary buddy designation may be removed in a variety of manners. For example, a user could drag-and-drop a primary buddy object from a primary buddy list into a trashcan icon, or the user could select a primary buddy object and then hit a “delete” key.

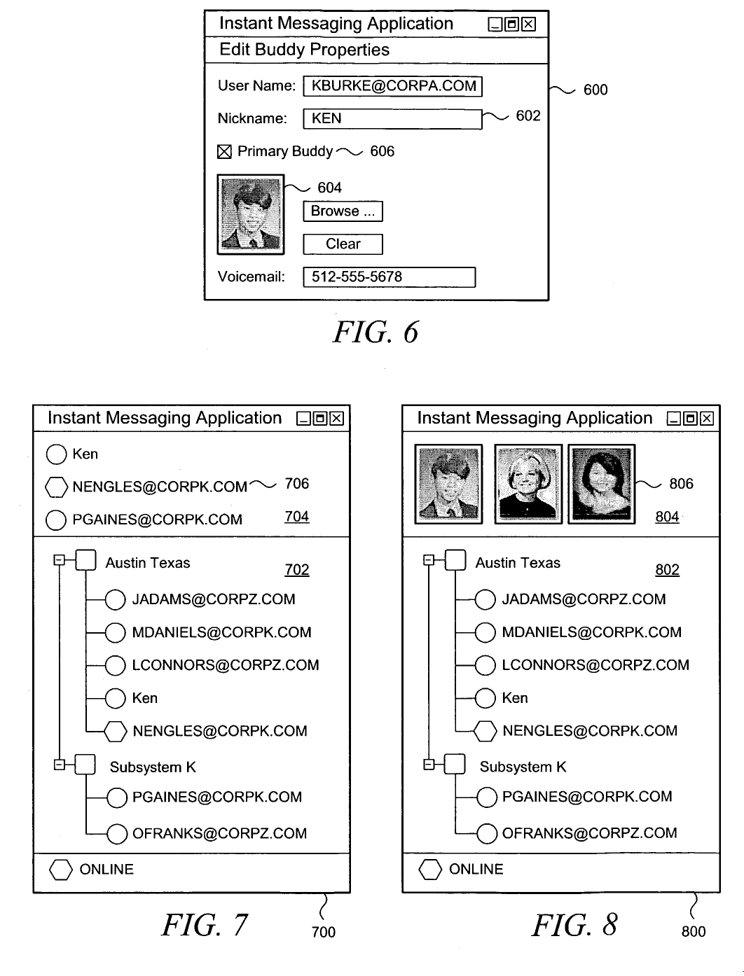

With reference now to FIG. 6, a diagram depicts a graphical user interface window for allowing a user to edit the properties of a buddy object in instant messaging application in order to designate a buddy object as a primary buddy object in accordance with the present invention. Window 600 displays various properties that are associated with a buddy object. A user of the instant messaging application can edit, select, or otherwise modify the property values and other informational data items that are associated with a buddy object. Property 602 is an mnemonic identifier that is associated with the buddy object; the instant messaging application may use the mnemonic identifier to represent the buddy object within in a text-based list of buddy objects. Property 604 is a thumbnail image that is associated with the buddy object; the instant messaging application may use the thumbnail image to represent the buddy object within an image-based list of buddy objects.

Checkbox 606 is a primary buddy object property for the buddy object that is processed by the instant messaging application in accordance with one embodiment of the present invention. By selecting or setting the checkbox, the user designates a buddy object as a primary buddy object; by deselecting or clearing the checkbox, the user removes the primary buddy designation that was previously associated with the buddy object.

With reference now to FIGS. 7-9, diagrams depict graphical user interface windows that show a primary buddy list in an instant messaging application. Referring to FIG. 7, window 700 is a GUI window for a buddy list within an instant messaging application in a manner similar to FIG. 2C. Buddy list area 702 shows multiple buddies in a buddy list, and the buddy list is organized in a hierarchical fashion with buddies possibly included within a group of buddies.

In contrast with FIG. 2C, FIG. 7 shows primary buddy list area 704 with multiple primary buddy objects. Each primary buddy object, such as primary buddy object 706, is a buddy object that has been previously designated by the user as a primary buddy object through an appropriate user action, such as those described above with respect to FIG. 4, i.e. a drag-and-drop operation, and FIG. 5, i.e. a property editing operation. Primary buddy objects may be selected in an appropriate manner to initiate an instant messaging session, e.g., by allowing a user to perform a certain operation on the primary buddy object with a user input device, such as double-clicking on the primary buddy object.

In the example that is shown in FIG. 7, each primary buddy object that is shown in the primary buddy list remains shown in the buddy list; in this manner, the primary buddy list is a subset of the buddy list. Alternatively, when a buddy object is designated as a primary buddy object by a user, then the newly designated primary buddy object could be removed from the buddy list when it is placed into the primary buddy list; in this manner, the primary buddy list and the buddy list would be processed independently and/or separately. The instant messaging application may display an additional visual indicator for each buddy object that has been designated as a primary buddy object in a manner similar to the visual indicator for its online/offline status.

Referring to FIG. 8, buddy list area 802 is displayed in a child window of window 800, and primary buddy list area 804 is displayed in a child window of window 800. In contrast to FIG. 7, which shows a text-based primary buddy list, FIG. 8 shows a primary buddy list that comprises thumbnail images, such as thumbnail 806, each of which represents a primary buddy object. By showing primary buddy objects with their associated thumbnail images rather than their textual identifiers, primary buddy objects have a more visually prominent display of information.

In the examples shown in FIG. 7 and FIG. 8, the primary list area is displayed within a content area of a first child window of a parent window, and the buddy list area is displayed within a content area of a second child window of a parent window; these child windows are sometimes referred to as subwindows of a main window. The instant messaging application is able to control each of these windows to affect the display of the windows. However, an implementation of the present invention could present the primary buddy list window and the buddy list window in independent and separate windows.

In an alternative embodiment, the instant messaging application may provide a primary buddy list window that acts as a dockable window within the docking areas of a desktop, as supported by the Microsoft Windows-family of operating systems. Other alternative windows could be used for the primary buddy list window.

Referring to FIG. 9, a primary buddy list window is shown as being incorporated into a system status area of a graphical user interface, such as the system tray area of the Microsoft Windows-family of operating systems. System tray 900 displays the current time along with various icons for certain applications. In this embodiment, system tray 900 also includes primary buddy list icon 902, which when selected by a user, displays primary buddy list window 904 as a pop-up menu containing each primary buddy object as a menu item that may be selected to initiate an instant messaging session.

The advantages of the present invention should be apparent in view of the detailed description that is provided above. Over time, a user's buddy list tends to grow in length and can often contain numerous entries, particularly within a corporate environment in which a user is often adding more buddies for temporary projects and purposes. After a buddy list grows in excess of a couple of dozen users, it becomes much more inconvenient to access a given buddy within one's buddy list.

The present invention provides a mechanism for managing access to a subset of a user's buddy list within an instant messaging application. Individual buddies can be marked as primary buddies, which are viewed in a primary buddy list that is a subset of the complete buddy list. Hence, those buddies with whom a user chats frequently, or those buddies that a user wants to monitor their online status frequently, can be designated as primary buddies. The primary buddy list view can be displayed separately from the complete buddy list, preferably in some manner that allows the primary buddy list to be displayed more prominently on the user's desktop. By having the primary buddy list easily available, the user's instant messaging operations are much more efficient. For example, the user does not need to scroll through a long buddy list to find a buddy with whom the user chats frequently. In an corporate environment in which a user may chat with some people frequently yet on a temporary basis, e.g., for a short-term project, the user can quickly designate these contacts as primary buddies then remove the primary buddy designation at some later time after the short-term project is complete.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for organizing user information in an instant messaging application, the method comprising:
displaying information associated with a buddy object within a first window of the instant messaging application, wherein a buddy object represents a user of an instant messaging application;
receiving a request from a user to designate the buddy object as a primary buddy object; and
in response to receiving the request from the user, displaying information associated with the buddy object in a second window of the instant messaging application, wherein the second window contains information associated with primary buddy objects.

2. The method of claim 1 wherein the request from the user further comprises:
dragging a representation of the buddy object from the first window of the instant messaging application to the second window of the instant messaging application.

3. The method of claim 1 wherein the request from the user further comprises:
selecting a user control indicating an optional primary buddy property value for the buddy object.

4. The method of claim 1 wherein the first window is a parent window of the second window.

5. The method of claim 1 wherein the second window is associated with a system status area of an operating system supporting the instant messaging application.

6. The method of claim 1 wherein primary buddy objects that are displayed in the second window are a subset of buddy objects that are displayed in the first window.

7. An apparatus for organizing user information in an instant messaging application, the apparatus comprising:
means for displaying information associated with a buddy object within a first window of the instant messaging application, wherein a buddy object represents a user of an instant messaging application;
means for receiving a request from a user to designate the buddy object as a primary buddy object; and
means for displaying information associated with the buddy object in a second window of the instant messaging application in response to receiving the request from the user, wherein the second window contains information associated with primary buddy objects.

8. The apparatus of claim 7 wherein the request from the user further comprises:
means for dragging a representation of the buddy object from the first window of the instant messaging application to the second window of the instant messaging application.

9. The apparatus of claim 7 wherein the request from the user further comprises:
means for selecting a user control indicating an optional primary buddy property value for the buddy object.

10. The apparatus of claim 7 wherein the first window is a parent window of the second window.

11. The apparatus of claim 7 wherein the second window is associated with a system status area of an operating system supporting the instant messaging application.

12. The apparatus of claim 7 wherein primary buddy objects that are displayed in the second window are a subset of buddy objects that are displayed in the first window.

13. A computer program product in a computer readable medium for organizing user information in an instant messaging application in a data processing system, the computer program product comprising:
means for displaying information associated with a buddy object within a first window of the instant messaging application, wherein a buddy object represents a user of an instant messaging application;
means for receiving a request from a user to designate the buddy object as a primary buddy object; and
means for displaying information associated with the buddy object in a second window of the instant messaging application in response to receiving the request from the user, wherein the second window contains information associated with primary buddy objects.

14. The computer program product of claim 13 wherein the request from the user further comprises:
means for dragging a representation of the buddy object from the first window of the instant messaging application to the second window of the instant messaging application.

15. The computer program product of claim 13 wherein the request from the user further comprises:
means for selecting a user control indicating an optional primary buddy property value for the buddy object.

16. The computer program product of claim 13 wherein the first window is a parent window of the second window.

17. The computer program product of claim 13 wherein the second window is associated with a system status area of an operating system supporting the instant messaging application.

18. The computer program product of claim 13 wherein primary buddy objects that are displayed in the second window are a subset of buddy objects that are displayed in the first window.
